(19) United States
(12) Patent Application Publication
(10) Pub. No.: US 2010/0060524 A9
(43) Pub. Date: Mar. 11, 2010

(54) INTEGRATED ANTENNA WITH IDENTICAL GROUND MEMBER

(75) Inventors: Shinichiro Okamura, Kyotanabe-shi (JP); Hisashi Ozawa, Kusatsu-shi (JP); Yuzo Okano, Kusatsu-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/188,108

(22) Filed: Aug. 7, 2008

(30) Foreign Application Priority Data
Aug. 10, 2007 (JP) 2007-209167

(51) Int. Cl. H01Q 1/38

(52) U.S. Cl. 343/700 MS

(57) ABSTRACT

The present invention provides an integrated antenna with an identical ground member, in which the interference between the adjacent antennas can be suppressed while the antenna is miniaturized in not only the width direction but also the height direction. In the integrated antenna with the identical ground member, plural antenna elements having two different resonance frequency bands are disposed in an identical ground member. Each antenna element includes a first radiation portion corresponding to one of the resonance frequency bands and a second radiation portion corresponding to the other resonance frequency band. At a point where the two antenna elements are adjacent to each other, a dielectric material is disposed in one of radiation portions located inside the antenna element such that the dielectric material contacts the radiation portion.

### BACKGROUND OF THE INVENTION

1. Field of the Invention

The present invention relates to an integrated antenna with an identical ground member, in which plural antennas resonating with different frequency bands are disposed in the identical ground member.

2. Description of the Related Art

Recently, with spread and advancement of a mobile information communication device, there is a demand for brief communication of large-capacity data. A diversity technique in which plural receiving antennas are disposed to reduce multipath phasing and a MIMO (Multiple Input Multiple Output) technique in which the speed enhancement is achieved by disposing plural transmitting and receiving antennas to increase the number of communication transmission lines are put to practical use in order to realize improvement of wireless communication quality and speed enhancement of the mobile information communication device.

The number of antennas mounted on the mobile information communication device is increased with adoptions of these techniques. For example, as shown in FIG. 11A, two antennas for wireless LAN are mounted on a conventional notebook personal computer. Recently, it is necessary that three antennas for wireless LAN be mounted as shown in FIG. 11B or two antennas for wireless LAN and an antenna for other systems (Bluetooth/UWB (Ultra Wide Band)/GPS) be mounted as shown in FIG. 11C. In the future, it is expected that the number of mounted antennas be increased with the further demand. In the case where the many antennas are mounted, it is also necessary that at least two antenna elements be mounted for one ground member.

On the other hand, miniaturization of the mobile information communication device advances year by year. In the case where the plural antenna elements are mounted for the one ground member, acquirement of a distance between antenna elements enough to suppress interference between the antenna elements becomes increasingly difficult. When the interference between the antenna elements is generated, because a radio wave which should be radiated from one antenna element is absorbed by the other antenna element, radiant efficiency of the radio wave is decreased to cause slowdown of a communication speed.

In order to solve the problem, for example, Japanese Patent Application Laid-Open No. 2006-74446 discloses a configuration in which plural antenna elements are separately mounted in an area where the antenna elements do not overlap a formation range of a ground conductive portion. Specifically, the ground conductive portion (a part of the ground member) is disposed between the two antenna elements, and the ground conductive portion is formed so as to surround each antenna element. In the configuration, the ground conductive portion disposed between the two antenna elements suppresses the interference between the antenna elements. Thus, a space surrounding the antenna element is effectively utilized to provide the ground conductive portion, so that the interference between the two antenna elements can be suppressed without enlarging a dielectric material substrate.

Japanese Patent Application Laid-Open No. 2007-13643 discloses an integrated plate multi-element antenna including a ground pattern (a part of the ground member) in which a notch is formed at an edge thereof, a first antenna element disposed on one side of the notch to have a feed portion, and a second antenna element disposed on the other side of the notch to have a feed portion. In the integrated plate multi-element antenna, characteristics of the antenna elements are separated by providing the notch in the ground pattern, whereby the interference between the antenna elements can be suppressed.

However, in the configuration of Japanese Patent Application Laid-Open No. 2006-74446, because the ground conductive portion disposed between the two antenna elements is formed so as to surround each antenna element, the ground conductive portion also exists in an upper portion of the antenna element, which results in a problem of an increased dimension in a height direction.

In the configuration of Japanese Patent Application Laid-Open No. 2007-13643, because the notch is formed in the ground member, the dimension in the height direction needs to provide the notch, which also results in the problem of the increased dimension in the height direction.

In view of the foregoing, the present invention realizes an integrated antenna with an identical ground member, in which the interference between the adjacent antennas can be suppressed while the antenna is miniaturized in not only the width direction but also the height direction.

### SUMMARY OF THE INVENTION

In accordance with one or more embodiments of the present invention, an integrated antenna with an identical ground member has a configuration, in which plural antenna elements are disposed in an identical ground member, the antenna element having two different resonance frequency bands, wherein each antenna element includes a first radiation portion corresponding to one of the resonance frequency bands and a second radiation portion corresponding to the other resonance frequency band, and at a point where the two antenna elements are adjacent to each other, a dielectric material is disposed in one of radiation portions located inside the antenna elements with respect to the adjacent portion such that the dielectric material contacts the radiation portion.

According to one or more embodiments of the present invention, even if the distance between the two adjacent antenna elements is not increased, the dielectric material largely attenuates a high-frequency signal transmitted from one of the antenna elements to the other antenna element in midstream, so that the interference between the antenna elements can be suppressed. The arrangement of the dielectric material does not cause the increased dimensions of the antenna in not only the width direction but also the height direction, so that the arrangement of the dielectric material can contribute to the miniaturization of the antenna. As used herein, the ground member shall include a printed circuit board having a grounded conductive portion and a metal member in which at least a part is grounded.

In the integrated antenna with the identical ground member according to one or more embodiments of the present invention, the radiation portion where the dielectric material is disposed may be a radiation portion corresponding to a lower resonance frequency band in the two radiation portions located inside the antenna elements with respect to the adjacent portion.

Accordingly, a large volume of the dielectric material is ensured and a high-frequency signal attenuation effect is improved by the dielectric material, so that the effect for suppressing the interference between the antenna elements can be improved.

In the integrated antenna with the identical ground member according to one or more embodiments of the present invention, the two resonance frequency bands may be pursuant to IEEE 802.11a/b/g, and the radiation portion where the dielectric material is disposed may be a radiation portion corresponding to 2.4 GHz-band resonance.

In the integrated antenna with the identical ground member according to one or more embodiments of the present invention, the two adjacent antenna elements may be disposed such that a radiation portion corresponding to 5 GHz-band resonance is located inside in one of the antenna elements while a radiation portion corresponding to 2.4 GHz-band resonance is located inside in the other antenna element.

In the integrated antenna with the identical ground member according to one or more embodiments of the present invention, an antenna shape of each antenna element may be formed into an inverted F-shape in which a part of a short-circuit portion is disposed in parallel with the first and second radiation portions, the short-circuit portion connecting the first and second radiation portions to a ground member.

In the integrated antenna with the identical ground member according to one or more embodiments of the present invention, an antenna shape of each antenna element may be formed into a T-shape in which a short-circuit portion is disposed perpendicular to the first and second radiation portions, the short-circuit portion connecting the first and second radiation portions to a ground member.

Thus, the integrated antenna with the identical ground member according to one or more embodiments of the present invention has a configuration, in which the plural antenna elements are disposed in the identical ground member, the antenna element having the two different resonance frequency bands, each antenna element includes the first radiation portion corresponding to one of the resonance frequency bands and the second radiation portion corresponding to the other resonance frequency band, and at a point where the two antenna elements are adjacent to each other, a dielectric material is disposed in one of the radiation portions located inside the antenna elements with respect to the adjacent portion such that the dielectric material contacts the radiation portion.

Therefore, even if the distance between the two adjacent antenna elements is not increased, the dielectric material largely attenuates the high-frequency signal transmitted from one of the antenna elements to the other antenna element in midstream, so that advantageously the interference between the antenna elements can be suppressed. Additionally, the arrangement of the dielectric material does not cause the increased dimensions of the antenna in not only the width direction but also the height direction, so that advantageously the arrangement of the dielectric material can contribute to the miniaturization of the antenna.

### BRIEF DESCRIPTION OF THE DRAWINGS

FIG. 1 shows a front view of a schematic configuration of an integrated antenna with an identical ground member according to one or more embodiments of the invention;

FIGS. 2A and 2B show signal interference between two adjacent antenna elements in the integrated antenna with the identical ground member, FIG. 2A shows a front view in the case where the two antenna elements are disposed while separated from each other, and FIG. 2B shows a front view in the case where the two antenna elements are disposed while brought close to each other;

FIG. 3 shows signal interference between two adjacent antenna elements in the integrated antenna with the identical ground member, and FIG. 3 is a front view in the case where a dielectric material is disposed in one of the antenna elements;

FIG. 4 shows a perspective view of a shape example of the integrated antenna with the identical ground member according to one or more embodiments of the invention;

FIGS. 5A and 5B show front views of examples of an arrangement relationship of two adjacent antenna elements and a disposition point of the dielectric material in the integrated antenna with the identical ground member, FIG. 5A shows a configuration in which the dielectric material is not provided, and FIG. 5B shows a configuration in which the dielectric material is provided;

FIGS. 6A and 6B show front views of examples of an arrangement relationship of two adjacent antenna elements and a disposition point of the dielectric material in the integrated antenna with the identical ground member, FIG. 6A shows a configuration in which the dielectric material is not provided, and FIG. 6B shows a configuration in which the dielectric material is provided;

FIGS. 7A and 7B show front views of examples of an arrangement relationship of two adjacent antenna elements and a disposition point of the dielectric material in the integrated antenna with the identical ground member, FIG. 7A shows a configuration in which the dielectric material is not provided, and FIG. 7B shows a configuration in which the dielectric material is provided;

FIGS. 8A and 8B show front views of examples of an arrangement relationship of two adjacent antenna elements and a disposition point of the dielectric material in the integrated antenna with the identical ground member, FIG. 8A shows a configuration in which the dielectric material is not provided, and FIG. 8B shows a configuration in which the dielectric material is provided;

FIGS. 9A to 9C show front views of configurations of arrangement relationships between the dielectric material and the antenna element;

FIGS. 10A and 10B show front views of examples of an arrangement relationship of two adjacent antenna elements and a disposition point of the dielectric material in the case where the two adjacent antenna elements are formed into a T-shape in the integrated antenna with the identical ground member, FIG. 10A shows a configuration in which the dielectric material is not provided, and FIG. 10B shows a configuration in which the dielectric material is provided; and

FIGS. 11A to 11C show configurations of plural antennas mounted on a notebook personal computer.

### DETAILED DESCRIPTION OF THE EMBODIMENTS

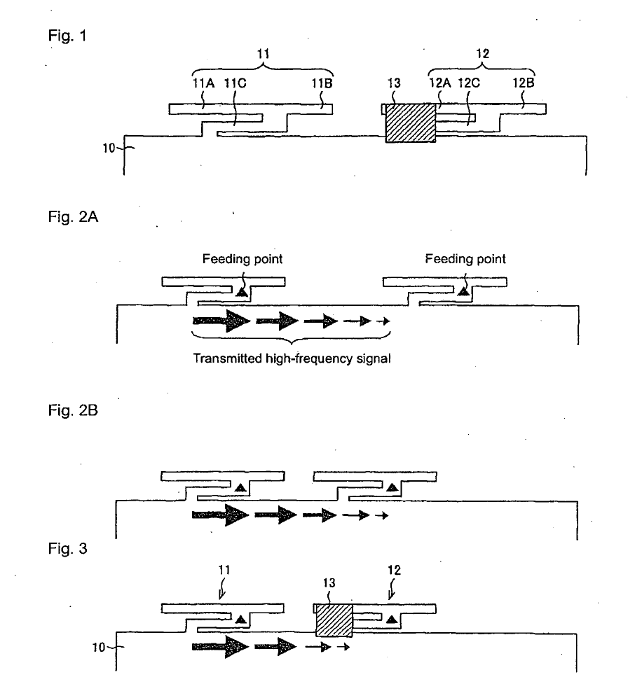

One or more embodiments of the present invention will be described below with reference to FIGS. 1 to 10. A schematic configuration of an integrated antenna with an identical ground member according to one or more embodiments of the present invention will be described with reference to FIG. 1.

In the integrated antenna with the identical ground member of FIG. 1, two antenna elements 11 and 12 are mounted on a ground member 10. The antenna element 11 includes a first radiation portion 11A, a second radiation portion 11B, and a short-circuit portion 11C. The short-circuit portion 11C connects the first radiation portion 11A and the second radiation portion 11B to the ground member 10, and a feeding point is located in the short-circuit portion 11C. The first radiation portion 11A and the second radiation portion 11B have the different resonance frequency bands, and a length from the feeding point to a front end of the radiation portion is equal to one quarter of a wavelength in a radio wave of the corresponding resonance frequency.

The antenna element 12 has the configuration similar to that of the antenna element 11, and the antenna element 12 includes a first radiation portion 12A, a second radiation portion 12B, and a short-circuit portion 12C.

Each of the antenna elements 11 and 12 has the two radiation portions having the different resonance frequency bands, so that each of the antenna elements 11 and 12 can radiate or absorb radio signals corresponding to the two kinds of the frequency bands. In FIG. 1, the two kinds of frequency bands are pursuant to IEEE 802.11a/b/g of the wireless LAN standard, the first radiation portions 11A and 12A correspond to 2.4 GHz-band resonance, and the second radiation portions 11B and 12B correspond to 5 GHz-band resonance. At this point, because the first radiation portions 11A and 12A have the lower frequency band (longer wavelength), the first radiation portions 11A and 12A are formed longer than the second radiation portions 11B and 12B.

As described above in the conventional technique, in the two antenna elements 11 and 12 which are disposed adjacent to each other in the identical ground member 10, the interference problem is generated between the antenna elements when the antenna elements 11 and 12 are disposed while brought close to each other. As shown in FIG. 2A, in the case where the two antenna elements are disposed while sufficiently separated from each other, the interference is not generated between the antenna elements because a high-frequency signal transmitted from one of the antenna elements propagates through the ground member 10 and attenuates until reaching the other antenna element. However, as shown in FIG. 2B, in the case where the two antenna elements are disposed while brought close to each other, the high-frequency signal transmitted from one of the antenna elements does not sufficiently attenuate, but the high-frequency signal reaches the other antenna element, thereby generating the interference between the antenna elements.

In the configuration of the integrated antenna with the identical ground member according to one or more embodiments of the present invention, a dielectric material 13 is provided on one side of the radiation portions located inside the two adjacent antenna elements 11 and 12. Therefore, even if the distance between the two adjacent antenna elements is not increased, the high-frequency signal attenuates largely by the dielectric material 13 as shown in FIG. 3, which causes the interference between the antenna elements to be suppressed.

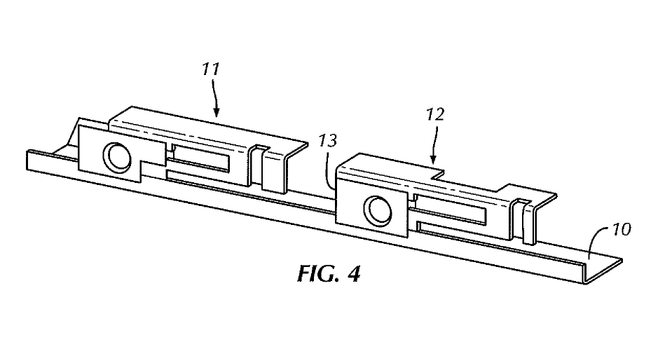

Basically the integrated antenna with the identical ground member is produced by performing sheet metal working such as punching and folding to a conductive plate of a material. FIG. 4 shows a perspective view of a specific example of the integrated antenna with the identical ground member according to one or more embodiments of the present invention. In FIG. 4, a feed wiring 14 including a concentric cable is connected to the feeding points of the antenna elements 11 and 12.

The integrated antenna with the identical ground member of one or more embodiments of the present invention will be described in detail. An advantage of the case in which an arrangement relationship of the two adjacent antenna elements and a disposition point of the dielectric material are changed will be described. Referring to FIG. 1, the second radiation portion 11B corresponding to 5 GHz-band resonance in the antenna element 11 and the first radiation portion 12A corresponding to 2.4 GHz-band resonance in the antenna element 12 are disposed inside, and the dielectric material 13 is provided on the side of the radiation portion 12A which is of the lower frequency side in the two radiation portions. However, the present invention is not limited to the integrated antenna with the identical ground member of the embodiment, but the arrangement relationship of the two adjacent antenna elements and the disposition point of the dielectric material may be changed.

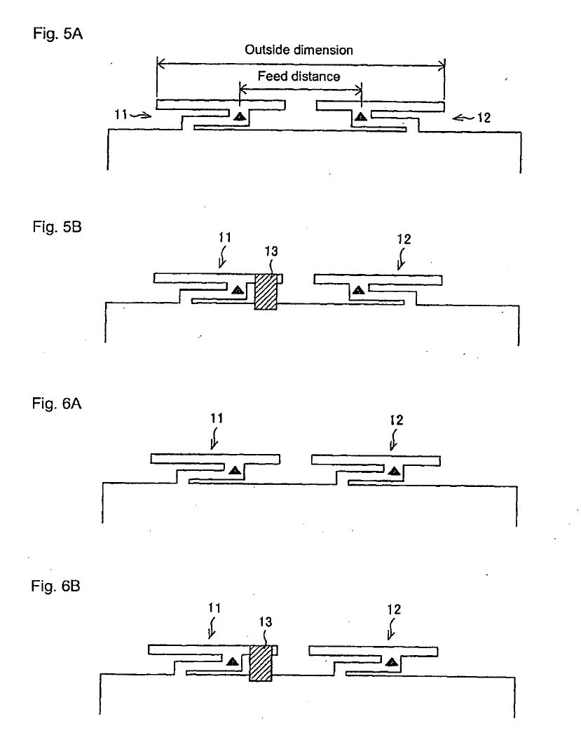

Referring to FIGS. 5A and 5B, the second radiation portion 11B corresponding to 5 GHz-band resonance in the antenna element 11 and the second radiation portion 12B corresponding to 5 GHz-band resonance in the antenna element 12 are disposed inside. FIG. 5A shows a configuration in which the dielectric material 13 is not provided, and FIG. 5B shows a configuration in which the dielectric material 13 is provided on the side of the radiation portion 11B. Table 1 shows computation results of isolation factors in the configurations of FIGS. 5A and 5B. An isolation factor A can be computed by the following equation.

A=S21/(1−S11)(1−S22)

S21: signal mount leaking from antenna 1 to antenna 2

S11: reflection amount of antenna 1

S22: reflection amount of antenna 2

TABLE 1

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 30 mm | 82 mm | 0.1106883 | 0.1485667 |
| dielectric | | | | | | | |
| material | | | | | | | |
| With | 8 | 1 | 33.28 mm³ | 30 mm | 82 mm | 0.1082929 | 0.1239625 |
| dielectric | | | | | | | |
| material | | | | | | | |
| | | | | | Difference | 0.0023954 | 0.0246042 |

In the configuration of FIG. 5A in which the dielectric material 13 is not provided, because the distance between the two antenna elements corresponding to the 2.4 GHz-band resonance is smaller than a wavelength of the 2.4 GHz-band frequency (the two antenna elements are brought closer to each other), the isolation factor for the 2.4 GHz band has a relatively large value. Because the distance between the two antenna elements corresponding to the 5 GHz-band resonance is smaller than a wavelength of the 5 GHz-band frequency, the isolation factor for the 5 GHz band also has a relatively large value.

On the other hand, in the configuration of FIG. 5B in which the dielectric material 13 is provided on the side of the radiation portion 11B, the isolation factors for the 2.4 GHz band and 5 GHz band are lowered. That is, the interference between the adjacent antenna elements is suppressed by providing the dielectric material 13.

Referring to FIGS. 6A and 6B, the second radiation portion 11B corresponding to 5 GHz-band resonance in the antenna element 11 and the first radiation portion 12A corresponding to the 2.4 GHz-band resonance in the antenna element 12 are disposed inside. FIG. 6A shows a configuration in which the dielectric material 13 is not provided, and FIG. 6B shows a configuration in which the dielectric material 13 is provided on the side of the radiation portion 11B. Table 2 shows computation results of isolation factors in the configurations of FIGS. 6A and 6B.

TABLE 2

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 46 mm | 82 mm | 0.0900339 | 0.0256267 |
| dielectric | | | | | | | |
| material | | | | | | | |
| With | 8 | 0.1 | 33.28 mm³ | 46 mm | 82 mm | 0.0864762 | 0.0240133 |
| dielectric | | | | | | | |
| material | | | | | | | |
| | | | | | Difference | 0.0035576 | 0.0016134 |

In the configuration of FIG. 6A in which the dielectric material 13 is not provided, because the distance between the two antenna elements corresponding to the 2.4 GHz-band resonance is smaller than the wavelength of the 2.4 GHz-band frequency, the isolation factor for the 2.4 GHz band has a relatively large value. Because the distance between the two antenna elements corresponding to the 5 GHz-band resonance is larger than the wavelength of the 5 GHz-band frequency, the isolation factor for the 5 GHz band also has a relatively small value.

On the other hand, in the configuration of FIG. 6A in which the dielectric material 13 is provided on the side of the radiation portion 11B, particularly the isolation factor is lowered for the 2.4 GHz band in which the isolation factor becomes large when the dielectric material 13 is not provided. That is, the interference between the adjacent antenna elements is suppressed by providing the dielectric material 13. In the 5 GHz band in which the isolation factor is originally small, the interference suppression effect is small even if the dielectric material 13 is provided.

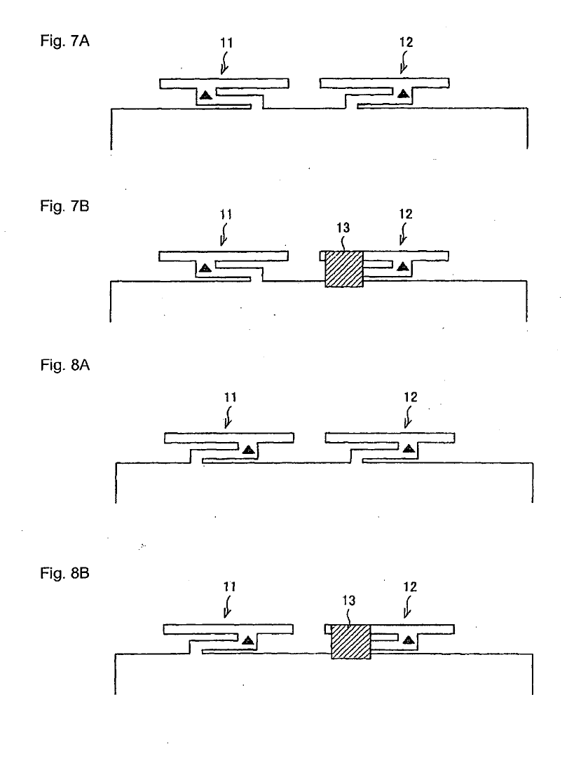

Referring to FIGS. 7A and 7B, the first radiation portion 11A corresponding to the 2.4 GHz-band resonance in the antenna element 11 and the first radiation portion 12A corresponding to the 2.4 GHz-band resonance in the antenna element 12 are disposed inside. FIG. 7A shows a configuration in which the dielectric material 13 is not provided, and FIG. 7B shows a configuration in which the dielectric material 13 is provided on the side of the radiation portion 12A. Table 3 shows computation results of isolation factors in the configurations of FIGS. 7A and 7B.

TABLE 3

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 62 mm | 82 mm | 0.1077716 | 0.0101283 |
| dielectric | | | | | | | |
| material | | | | | | | |
| With | 8 | 0.1 | 52 mm³ | 62 mm | 82 mm | 0.0661838 | 0.0103147 |
| dielectric | | | | | | | |
| material | | | | | | | |
| | | | | | Difference | 0.0415878 | −0.000186 |

In the configuration of FIG. 7A in which the dielectric material 13 is not provided, because the distance between the two antenna elements corresponding to the 2.4 GHz-band resonance is smaller than the wavelength of the 2.4 GHz-band frequency, the isolation factor for the 2.4 GHz band has a relatively large value. Because the distance between the two antenna elements corresponding to the 5 GHz-band resonance is larger than the wavelength of the 5 GHz-band frequency, the isolation factor for the 5 GHz band also has a relatively small value.

On the other hand, in the configuration of FIG. 7B in which the dielectric material 13 is provided on the side of the radiation portion 11A, particularly the isolation factor is lowered for the 2.4 GHz band in which the isolation factor becomes large when the dielectric material 13 is not provided. That is, the interference between the adjacent antenna elements is suppressed by providing the dielectric material 13. In the 5 GHz band in which the isolation factor is originally small, the interference suppression effect is little even if the dielectric material 13 is provided.

The decrease in isolation factor for the 2.4 GHz band is much larger than those of FIGS. 5B and 6B. This is attributed to the fact that, in the configuration of FIG. 7B, the volume of the dielectric material 13 can be increased by providing the dielectric material 13 on the side of the first radiation portion 12A corresponding to the 2.4 GHz-band resonance, thereby improving the high-frequency signal attenuation effect by the dielectric material 13. That is, in the case where the dielectric material 13 is provided on the radiation portion side corresponding to the 5 GHz-band resonance, because the radiation portion corresponding to the 5 GHz-band resonance is shorter than the radiation portion corresponding to the 2.4 GHz-band resonance, it is necessary to decrease the dimension of the dielectric material 13, and therefore the high-frequency signal attenuation effect becomes small.

Referring to FIGS. 8A and 8B, the second radiation portion 11B corresponding to 5 GHz-band resonance in the antenna element 11 and the first radiation portion 12A corresponding to 2.4 GHz-band resonance in the antenna element 12 are disposed inside. FIG. 8A shows an example in which the dielectric material 13 is not provided, and FIG. 8B shows an example in which the dielectric material 13 is provided on the side of the radiation portion 12A. Table 4 shows computation results of isolation factors in the configurations of FIGS. 8A and 8B.

TABLE 4

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 46 mm | 82 mm | 0.0900339 | 0.0256267 |
| dielectric | | | | | | | |
| material | | | | | | | |
| With | 8 | 0.1 | 52 mm³ | 46 mm | 82 mm | 0.0579252 | 0.023646 |
| dielectric | | | | | | | |
| material | | | | | | | |
| | | | | | Difference | 0.0321087 | 0.0019806 |

In the configuration of FIG. 8A in which the dielectric material 13 is not provided, because the distance between the two antenna elements corresponding to the 2.4 GHz-band resonance is smaller than the wavelength of the 2.4 GHz-band frequency, the isolation factor for the 2.4 GHz band has a relatively large value. Because the distance between the two antenna elements corresponding to the 5 GHz-band resonance is larger than the wavelength of the 5 GHz-band frequency, the isolation factor for the 5 GHz band also has a relatively small value.

On the other hand, in the configuration of FIG. 8B in which the dielectric material 13 is provided on the side of the radiation portion 12A, particularly the isolation factor is lowered for the 2.4 GHz band in which the isolation factor becomes large when the dielectric material 13 is not provided. That is, the interference between the adjacent antenna elements is suppressed by providing the dielectric material 13. In the 5 GHz band in which the isolation factor is originally small, the interference suppression effect is little even if the dielectric material 13 is provided.

The configuration of FIG. 78 is larger than the configuration of FIG. 8B in the decrease in isolation factor for the 2.4 GHz band. This is because not only the configuration of FIG. 7B is smaller than the configuration of FIG. 8B in the distance between two antenna elements corresponding to the 2.4 GHz-band resonance, but also the configuration of FIG. 7B is larger than the configuration of FIG. 8B in the original isolation factor when the dielectric material 13 is not provided. However, the configuration of FIG. 7B is larger than the configuration of FIG. 8B in the isolation factor for the 2.4 GHz band when the dielectric material 13 is provided.

As is clear from FIGS. 5 to 8 and the results of Tables 1 to 4, the dielectric material 13 provided to suppress the interference between the antenna elements exerts the larger effect as the volume of the dielectric material 13 is increased. Therefore, in the two adjacent antenna elements 11 and 12, the dielectric material 13 may be provided on the side of the radiation portion having the lower resonance frequency band in the radiation portions located inside the antenna elements.

The interference between the adjacent antenna elements is generated more easily in the 2.4 GHz-band high-frequency signal having the corresponding wavelength larger than that of the 5 GHz-band high-frequency signal (that is, the interference is generated more easily in the lower frequency-side signal). Accordingly, it is not preferable that the radiation portions having the lower frequency-side resonance frequencies be disposed inside. The radiation portion having the lower frequency-side resonance frequency may be disposed inside in one of the antenna elements, the radiation portion having the higher frequency-side resonance frequency is disposed inside in the other antenna element, and the dielectric material 13 is provided on the radiation portion side having the lower frequency-side resonance frequency in the radiation portions located inside the antenna elements. From the above results, it can be said that the configuration of FIG. 8 is the most optimum in the configurations of FIGS. 58 to 8B.

In one or more embodiments, the antenna elements 11 and 12 may have the 5 GHz band as the higher frequency-side resonance frequency and the 2.4 GHz band as the lower frequency-side resonance frequency. However, the present invention is not limited to these embodiments. Table 5 shows computation result of isolation factors in the integrated antenna with the identical ground member corresponding to 1.5 GHz-band resonance and 3.5 GHz-band resonance. The result of Table 5 is obtained by conforming the arrangement relationship of the two adjacent antenna elements and the disposition point of the dielectric material to the example of arrangement shown in FIG. 8B.

TABLE 5

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 66 mm | 126 mm | 0.0553087 | 0.0404806 |
| dielectric | | | | | | | |
| material | | | | | | | |
| With | 8 | 0.1 | 114.4 mm³ | 66 mm | 126 mm | 0.0263473 | 0.0335576 |
| dielectric | | | | | | | |
| material | | | | | | | |
| | | | | | Difference | 0.0289614 | 0.006923 |

In the configuration in which the dielectric material 13 is not provided, because the distance between two antenna elements corresponding to the 1.5 GHz-band resonance is smaller than the wavelength of the 1.5 GHz-band frequency, the isolation factor for the 1.5 GHz band has a relatively large value. Because the distance between two antenna elements corresponding to the 3.5 GHz-band resonance is larger than the wavelength of the 3.5 GHz-band frequency, the isolation factor for the 3.5 GHz band has a relatively small value.

On the other hand, in the configuration in which the dielectric material 13 is provided, particularly the isolation factor is lowered for the 1.5 GHz band in which the isolation factor becomes large when the dielectric material 13 is not provided. The isolation factor is also lowered for the 3.5 GHz band. That is, the interference between the adjacent antenna elements is suppressed by providing the dielectric material 13.

The arrangement relationship between the dielectric material 13 and the antenna element will be described in the case where the dielectric material 13 is provided.

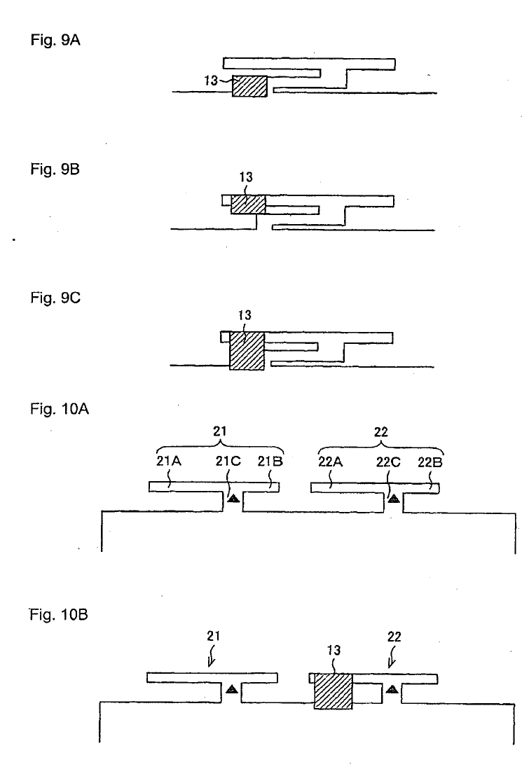

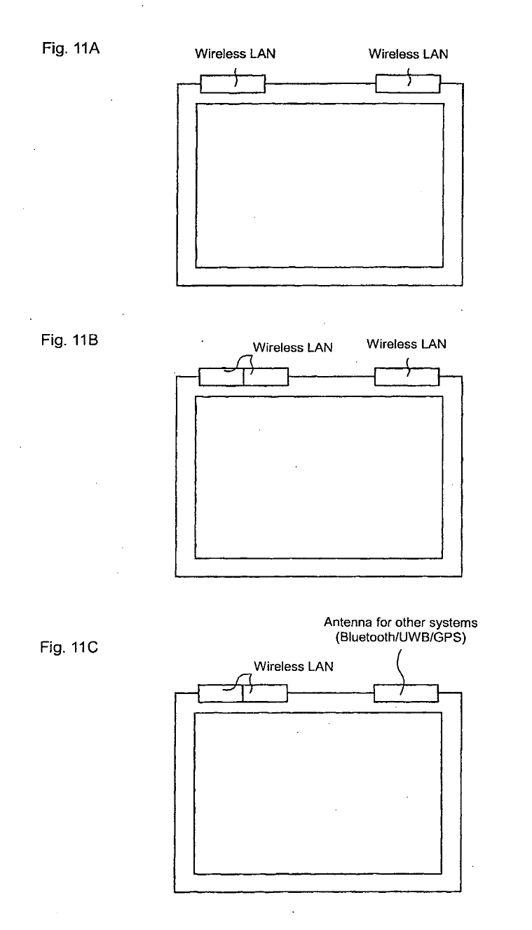

FIG. 9A shows a configuration in which the dielectric material 13 is disposed such that the ground member and short-circuit portion of the antenna element are covered with the dielectric material 13. FIG. 9B shows a configuration in which the dielectric material 13 is disposed such that only the radiation portion of the antenna element is covered with the dielectric material 13. FIG. 9C shows a configuration in which the dielectric material 13 is disposed such that the radiation portion, ground member, and short-circuit portion of the antenna element are covered with the dielectric material 13. Table 6 shows computation which of dielectric factors in the configurations of FIGS. 9A to 9C (the case in which the dielectric material is not provided is also shown for the purpose of comparison).

TABLE 6

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 46 mm | 82 mm | 0.0900339 | 0.0256267 |
| dielectric | | | | | | | |
| material | | | | | | | |
| FIG. 9A | 8 | 0.1 | 28 mm³ | 46 mm | 82 mm | 0.0888159 | 0.0272603 |
| FIG. 9B | 8 | 0.1 | 28 mm³ | 46 mm | 82 mm | 0.0690627 | 0.0234966 |
| FIG. 9C | 8 | 0.1 | 52 mm³ | 46 mm | 82 mm | 0.0579252 | 0.023646 |

In the configuration in which the ground member and the short-circuit portion are covered with the dielectric material 13 (the radiation portion is not covered), the isolation suppression effect is little compared with the configuration in which the dielectric material is not provided. In the configuration in which only the radiation portion is covered with the dielectric material 13, the isolation is suppressed compared with the configuration in which the dielectric material is not provided, and the dielectric material 13 may be formed such that at least the radiation portion of the antenna element is covered with the dielectric material 13. In the configuration in which the radiation portion, the ground member, and the short-circuit portion are covered with the dielectric material 13, the isolation factor becomes the lowest and the most optimum. The dielectric material 13 may be formed so as to sandwich the antenna element, which is made of a sheet metal using resin materials, from the both sides.

The arrangement relationship between the dielectric material 13 and the antenna element will be described in the case where the dielectric material 13 is provided.

In the above description, the shape of the antenna element has the so-called inverted F-shape in which a part of the short-circuit portion is disposed in parallel with the radiation portion. The present invention is not limited to the inverted F-shape. For example, as shown in FIG. 10B, one or more embodiments of the present invention can also be applied to an integrated antenna with an identical ground member provided with antenna elements 21 and 22 having a T-shape in which the short-circuit portion is disposed perpendicular to the radiation portion. The antenna elements 21 and 22 include first radiation portions 21A and 22A corresponding to the 2.4 GHz-band resonance and second radiation portion 21B and 22B corresponding to the 5 GHz-band resonance, and short-circuit portion 21C and 22C respectively. FIG. 10A shows a configuration in which the dielectric material 13 is not provided, and FIG. 10B shows a configuration in which the dielectric material 13 is provided on the side of the radiation portion 22A. Table 7 shows computation results of isolation factors in the configurations of FIGS. 10A and 10B.

TABLE 7

| | Characteristics of | | | | | | |
|---|---|---|---|---|---|---|---|
| | dielectric material | | | | | | |
| | | Dielectric | | | | | |
| | Dielectric | loss | | Feed | Outside | 2 G band | 5 G band |
| | constant | tangent | Volume | distance | dimension | Isolation factor | Isolation factor |
| Without | — | — | — | 50 mm | 80 mm | 0.0912478 | 0.0247667 |
| dielectric | | | | | | | |
| material | | | | | | | |
| With | 8 | 0.1 | 172.8 mm³ | 50 mm | 80 mm | 0.0813036 | 0.0123155 |
| dielectric | | | | | | | |
| material | | | | | | | |
| | | | | | Difference | 0.0099443 | 0.0124512 |

In the configuration of FIG. 10A in which the dielectric material 13 is not provided, because the distance between the two antenna elements corresponding to the 2.4 GHz-band resonance is smaller than the wavelength of the 2.40 Hz-band frequency, the isolation factor for the 2.4 GHz band has a relatively large value. Because the distance between the two antenna elements corresponding to the 5 GHz-band resonance is larger than the wavelength of the 5 GHz-band frequency, the isolation factor for the 5 GHz band has a relatively small value.

On the other hand, in the configuration of FIG. 10B in which the dielectric material 13 is provided on the side of the radiation portion 22A, the isolation factors are lowered for both the 2.4 GHz band and 5 GHz band. The interference between the adjacent antenna elements is suppressed by providing the dielectric material 13.

In one or more embodiments, there is described a case where the two antenna elements are mounted on the ground member. However, other embodiments of the present invention can be applied to a configuration in which at least three antenna elements are mounted on the ground member. In such cases, it is only necessary to dispose the dielectric material in at least one point where the two antenna elements are adjacent to each other.

The integrated antenna with the identical ground member according to one or more embodiments of the present invention can suitably be used in a transmitting and receiving apparatus such as the mobile information communication device.

1. An integrated antenna with an identical ground member, in which a plurality of antenna elements are disposed in an identical ground member, the antenna element having two different resonance frequency bands,
wherein each antenna element includes a first radiation portion corresponding to one of the resonance frequency bands and a second radiation portion corresponding to the other resonance frequency band, and
at a point where the two antenna elements are adjacent to each other, a dielectric material is disposed in one of radiation portions located inside the antenna elements with respect to the adjacent portion such that the dielectric material contacts the radiation portion.

2. The integrated antenna with the identical ground member according to claim 1, wherein the radiation portion where the dielectric material is disposed is a radiation portion corresponding to a lower resonance frequency band in the two radiation portions located inside the antenna elements with respect to the adjacent portion.

3. The integrated antenna with the identical ground member according to claim 2, wherein the two resonance frequency bands are pursuant to IEEE 802.11a/b/g, and the radiation portion where the dielectric material is disposed is a radiation portion corresponding to 2.4 GHz-band resonance.

4. The integrated antenna with the identical ground member according to claim 3, wherein the two adjacent antenna elements are disposed such that a radiation portion corresponding to 5 GHz-band resonance is located inside in one of the antenna elements while a radiation portion corresponding to 2.4 GHz-band resonance is located inside in the other antenna element.

5. The integrated antenna with the identical ground member according to claim 4, wherein an antenna shape of each antenna element is formed into an inverted F-shape in which a part of a short-circuit portion is disposed in parallel with the first and second radiation portions, the short-circuit portion connecting the first and second radiation portions to a ground member.

6. The integrated antenna with the identical ground member according to claim 3, wherein an antenna shape of each antenna element is formed into a T-shape in which a short-circuit portion is disposed perpendicular to the first and second radiation portions, the short-circuit portion connecting the first and second radiation portions to a ground member.

7. A transmitting and receiving apparatus comprising the integrated antenna with the identical ground member according to claim 1.

8. A transmitting and receiving apparatus comprising the integrated antenna with the identical ground member according to claim 2.

9. A transmitting and receiving apparatus comprising the integrated antenna with the identical ground member according to claim 3.

10. A transmitting and receiving apparatus comprising the integrated antenna with the identical ground member according to claim 4.

11. A transmitting and receiving apparatus comprising the integrated antenna with the identical ground member according to claim 5.

12. A transmitting and receiving apparatus comprising the integrated antenna with the identical ground member according to claim 6.
